(19) United States
(12) Patent Application Publication
(10) Pub. No.: US 2022/0221581 A1
(43) Pub. Date: Jul. 14, 2022

(54) DEPTH ESTIMATION DEVICE, DEPTH ESTIMATION METHOD, AND DEPTH ESTIMATION PROGRAM

(71) Applicant: NIPPON TELEGRAPH AND TELEPHONE CORPORATION, Tokyo (JP)

(72) Inventors: Go IRIE, Tokyo (JP); Takahito KAWANISHI, Tokyo (JP); Kunio KASHINO, Tokyo (JP)

(73) Assignee: NIPPON TELEGRAPH AND TELEPHONE CORPORATION, Tokyo (JP)

(21) Appl. No.: 17/613,044

(22) PCT Filed: May 21, 2019
(86) PCT No.: PCT/JP2019/020172

§ 371 Date: Nov. 20, 2021

(51) Int. Cl. G01S 15/42; G01S 15/32; G01S 7/539

(52) U.S. Cl. CPC G01S 15/42; G01S 7/539; G01S 15/32

(57) ABSTRACT

In a depth estimation device, a generation unit generates a predetermined attractive sound in a space to be measured. A sound pickup unit picks up an acoustic signal for a predetermined time period corresponding to a time period before and after a time of generation of the attractive sound. An estimation unit extracts a feature representing time-frequency information obtained through analysis of the acoustic signal, on the basis of the acoustic signal, and inputs the extracted feature representing the time-frequency information to a depth estimator and generates an estimated depth map for the space to be measured, the depth estimator being composed of one or more convolution operations and being learned so as to output an estimated depth map, in which a depth is assigned to each of pixels of an image representing the space to be measured, when a feature representing the time-frequency information is input.

### TECHNICAL FIELD

A technique disclosed herein relates to a depth estimation device, a depth estimation method, and a depth estimation program.

### BACKGROUND ART

Artificial intelligence (AI) techniques are making remarkable strides. Techniques for supporting various human activities in the real space, such as an advanced monitoring system, watching, and navigation based on smartphones and robots, are provided, and further development is about to be attained.

Requirements for an AI system which supports human activities include having means for correctly understanding a structure and a shape of a space where the system is placed. For example, if it is desired to track a given person, when the person has hidden in a place behind a thing, a system is expected to properly determine that the person to be tracked has a high likelihood of being in the place behind the thing. However, to make the determination, it is necessary to understand structural information that a space has a place behind a thing where a person can hide. For example, in the case of a robot which guides a user to a destination in an urban area, it is preferable to present, from a user's practical perspective, where and how to go in order to reach the destination. However, in this case as well, it is necessary to understand what a geographic structure leading up to the destination is like. In the case of a robot which transports a product, the robot may grasp a product on a goods shelf and transport the product, and transfer the product to another goods shelf. At this time, completion of the work of the robot needs correct recognition of structures and shapes of the goods shelves.

As described above, grasping a structure of a space is one of basic functions needed for many AI systems, and it can be said that great expectations are placed on a technique therefor.

A structure can be known by obtaining a three-dimensional geometrical shape, i.e., a width, a height, and a depth. In particular, measurement of depth information that is hard to measure from a single viewpoint is the linchpin of three-dimensional measurement.

There are many publicly known means for measuring a depth. For example, for a space up to 100 square meters, laser scanning by LiDAR (light detection and ranging/light imaging, detection, and ranging) can be utilized. This means, however, is generally relatively costly. For a general room interior, there are available a measurement method which uses a time of flight (ToF) camera using, e.g., infrared light or structured illumination, and the like. These means are all premised on utilization of a dedicated measurement device, and such a device cannot always be utilized.

As alternative means, a technique using a more common camera, i.e., an RGB image is well known. Although a width and a height can be read from one RGB image, depth information cannot be obtained. For this reason, there is a need for implementation of measurement using a plurality of images, such as using two or more images shot from different viewpoints as in the method described in Patent Literature 1 or using a stereo camera.

There is also disclosed a technique for estimating depth information from a single RGB image using mechanical learning in order to more easily obtain depth information. A method which has recently been in the mainstream is a method using a deep neural network, and the method directly learns a deep neural network which accepts as input an RGB image and directly outputs depth information of the image.

For example, Non-Patent Literature 1 discloses a method for learning a network based on a deep residual network (ResNet) disclosed in Non-Patent Literature 2 using the reverse Huber loss (berHu loss). The berHu loss is a piecewise function and is a function which is linear within a range with a small depth estimation error and is a quadratic function within a range with a large depth estimation error.

Non-Patent Literature 3 discloses a method for learning a network as in Non-Patent Literature 1 using a linear function for the L1 loss, i.e., an estimation error.

### CITATION LIST

### Patent Literature

Patent Literature 1: Japanese Patent Laid-Open No. 2017-112419

### Non-Patent Literature

Non-Patent Literature 1: Iro Laina, Christian Rupprecht, Vasileios Belagianis, Federico Tombari, and Nassir Navab, “Deeper Depth Prediction with Fully Convolutional Residual Networks,” In Proc. International Conference on 3D Vision (3DV), pp. 239-248, 2016.
Non-Patent Literature 2: Kaiming He, Xiangyu Zhang, Shaoqing Ren, and Jian Sun, “Deep Residual Learning for Image Recognition,” In Proc. Conference on Computer Vision and Pattern Recognition (CVPR), 2016.
Non-Patent Literature 3: Fangchang Ma and Sertac Karaman, “Sparse-to-Dense: Depth Prediction from Sparse Depth Samples and a Single Image,” In Proc. International Conference on Robotics and Automation (ICRA), 2018.
Non-Patent Literature 4: Ivan Dokmanic, Reza Parhizkar, Andreas Walther, Yue M. Lu, and Martin Vetterli, “Acoustic Echoes Reveal Room Shape,” Proc. National Academy of Sciences of the United States of America (PNAS), Vo. 110(30), pp. 12186-12191, 2013.

### SUMMARY OF THE INVENTION

### Technical Problem

Depth estimation techniques invented in these days typically suffer from the following problem. Due to the property that the depth estimation techniques involve use of a camera, the techniques cannot be utilized for a dark room interior which is invisible to a camera or a space which is not desired to be shot with a camera.

The disclosed technique has been made in view of the above-described matter, and has as its object to provide a depth estimation device, a depth estimation method, and a depth estimation program for estimating, with high accuracy, a depth of a space using an acoustic signal.

### Means for Solving the Problem

According to a first aspect of the present disclosure, there is provided a depth estimation device configured to include a generation unit that generates a predetermined attractive sound in a space to be measured, a sound pickup unit that picks up an acoustic signal for a predetermined time period corresponding to a time period before and after a time of generation of the attractive sound by the generation unit, and an estimation unit that extracts a feature representing time-frequency information obtained through analysis of the acoustic signal, on the basis of the acoustic signal, and inputs the extracted feature representing the time-frequency information to a depth estimator and generates an estimated depth map for the space to be measured, the depth estimator being composed of one or more convolution operations and being learned so as to output an estimated depth map, in which a depth is assigned to each of pixels of an image representing the space to be measured, when a feature representing the time-frequency information is input.

In the first aspect of the present disclosure, the depth estimation device may further include a learning unit, and the depth estimator may be learned by extracting, by the estimation unit, a feature representing time-frequency information through frequency analysis of a picked-up acoustic signal for learning and applying the depth estimator to the time-frequency information to generate an estimated depth map for learning, and updating, by the learning unit, a parameter for the depth estimator on the basis of a first loss value that is obtained from an error between the generated estimated depth map for learning and a correct depth map for the estimated depth map for learning.

In the first aspect of the present disclosure, the depth estimator may be learned by updating, by the learning unit, the parameter for the depth estimator on the basis of a second loss value obtained through reflection of edges detected for the space to be measured in the error, for the depth estimator updated on the basis of the first loss value.

According to a second aspect of the present disclosure, there is provided a depth estimation method wherein a computer executes a process, the process including generating a predetermined attractive sound in a space to be measured, picking up an acoustic signal for a predetermined time period corresponding to a time period before and after a time of generation of the attractive sound by a generation unit, extracting a feature representing time-frequency information obtained through analysis of the acoustic signal, on the basis of the acoustic signal, and inputting the extracted feature representing the time-frequency information to a depth estimator and generating an estimated depth map for the space to be measured, the depth estimator being composed of one or more convolution operations and being learned so as to output an estimated depth map, in which a depth is assigned to each of pixels of an image representing the space to be measured, when a feature representing the time-frequency information is input.

In the second aspect of the present disclosure, the depth estimator may be learned by extracting a feature representing time-frequency information through frequency analysis of a picked-up acoustic signal for learning and applying the depth estimator to the time-frequency information to generate an estimated depth map for learning, and updating a parameter for the depth estimator on the basis of a first loss value that is obtained from an error between the generated estimated depth map for learning and a correct depth map for the estimated depth map for learning.

In the second aspect of the present disclosure, the depth estimator may be learned by updating the parameter for the depth estimator on the basis of a second loss value obtained through reflection of edges detected for the space to be measured in the error, for the depth estimator updated on the basis of the first loss value.

According to a third aspect of the present disclosure, there is provided a depth estimation program, the program causing a computer to execute generating a predetermined attractive sound in a space to be measured, picking up an acoustic signal for a predetermined time period corresponding to a time period before and after a time of generation of the attractive sound by a generation unit, extracting a feature representing time-frequency information obtained through analysis of the acoustic signal, on the basis of the acoustic signal, and inputting the extracted feature representing the time-frequency information to a depth estimator and generating an estimated depth map for the space to be measured, the depth estimator being composed of one or more convolution operations and being learned so as to output an estimated depth map, a depth is assigned to each of pixels of an image representing the space to be measured, when a feature representing the time-frequency information is input.

### Effects of the Invention

According to the disclosed technique, it is possible to estimate, with high accuracy, a depth of a space using an acoustic signal.

### BRIEF DESCRIPTION OF DRAWINGS

FIG. 1 is a block diagram showing one aspect of a configuration of a depth estimation device according to an embodiment of the present disclosure.

FIG. 2 is a block diagram showing a hardware configuration of the depth estimation device.

FIG. 3 is a block diagram showing one aspect of the configuration of the depth estimation device according to the embodiment of the present disclosure.

FIG. 4 is a block diagram showing one aspect of the configuration of the depth estimation device according to the embodiment of the present disclosure.

FIG. 5 is a flowchart showing the flow of a learning process by a depth estimation device according to a first embodiment.

FIG. 6 is a flowchart showing the flow of a learning process by a depth estimation device according to a second embodiment.

### DESCRIPTION OF EMBODIMENTS

One example of an embodiment of the disclosed technique will be described below with reference to the drawings. Note that identical or equivalent constituent elements and portions are denoted by identical reference numerals in the drawings. Dimensional ratios in the drawings may be exaggerated and be different from actual ratios for convenience of description.

[Configuration of Embodiment]

A configuration according to the present embodiment will be described below. Note that although a first embodiment and a second embodiment will be separately described in a description of operation, the first and second embodiments are identical in configuration.

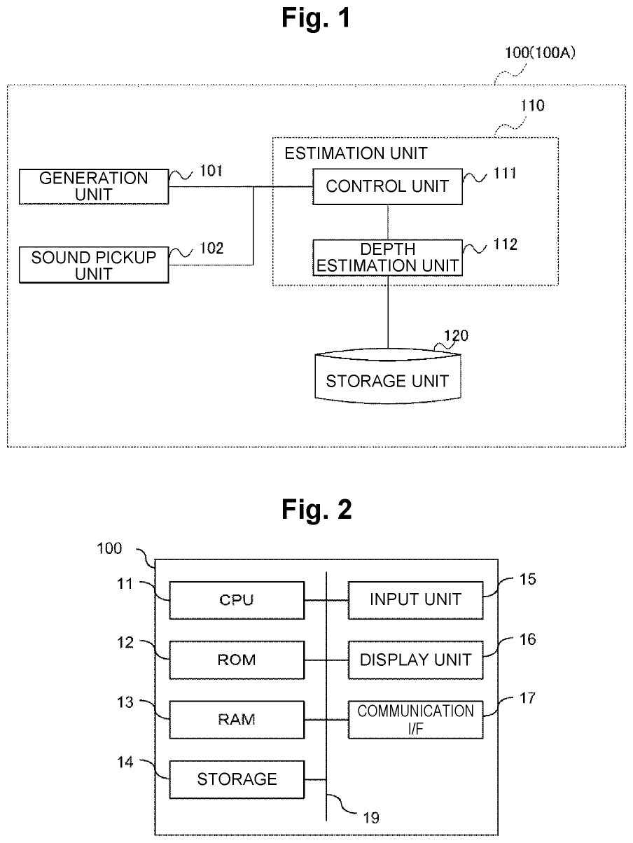

FIG. 1 is a block diagram showing a configuration of a depth estimation device 100 (a depth estimation device 100A: an alphabet may hereinafter be added depending on an aspect of a depth estimation device) according to the present embodiment.

As shown in FIG. 1, the depth estimation device 100 includes a generation unit 101, a sound pickup unit 102, an estimation unit 110, and a storage unit 120. The estimation unit 110 includes a control unit 111 and a depth estimation unit 112. The depth estimation device 100 is connected to the outside via communication means and intercommunicates information with the outside. The estimation unit 110 is connected to the generation unit 101, the sound pickup unit 102, and the storage unit 120 in a form capable of intercommunication of information.

FIG. 2 is a block diagram showing a hardware configuration of the depth estimation device 100.

As shown in FIG. 2, the depth estimation device 100 has a CPU (Central Processing Unit) 11, a ROM (Read Only Memory) 12, a RAM (Random Access Memory) 13, a storage 14, an input unit 15, a display unit 16, and a communication interface (I/F) 17. The components are connected so as to be capable of intercommunication via a bus 19.

The CPU 11 is a central processing unit, and executes various types of programs and controls the units. That is, the CPU 11 reads out a program from the ROM 12 or the storage 14 and executes the program using the RAM 13 as a work region. The CPU 11 performs control of the above-described components and various types of arithmetic processing in accordance with the program stored in the ROM 12 or the storage 14. In the present embodiment, a multitask learning program is stored in the ROM 12 or the storage 14.

The ROM 12 stores various types of programs and various types of data. The RAM 13 as a work region temporarily stores a program or data. The storage 14 is composed of an HDD (Hard Disk Drive) or an SSD (Solid State Drive) and stores various types of program including an operating system and various types of data.

The input unit 15 includes a pointing device, such as a mouse, and a keyboard and is used to perform various types of input.

The display unit 16 is, for example, a liquid crystal display and displays various types of information. A touch panel type one may be adopted as the display unit 16, and the display unit 16 may function as the input unit 15.

The communication interface 17 is an interface for communicating with different equipment, such as a terminal, and a standard, such as Ethernet®, FDDI, or Wi-Fi®, is used.

Functional components of the depth estimation device 100 will be described. Each functional component is implemented when the CPU 11 reads out the program stored in the ROM 12 or the storage 14, and develops the program in the RAM 13 and executing the program.

Anything may be used as the generation unit 101 as long as the thing can output sound to the outside under control of the control unit 111. A speaker or the like may be used. Similarly, anything may be used as the sound pickup unit 102 as long as the thing can pick up sound under control of the control unit 111. A microphone or the like may be used. Of course, the generation unit 101 and the sound pickup unit 102 may be composed of a plurality of speakers and a plurality of microphones. The generation unit 101 generates a predetermined attractive sound in a space to be measured. The sound pickup unit 102 picks up an acoustic signal for a predetermined time period starting before and ending after a time of generation of the attractive sound by the generation unit 101.

The estimation unit 110 causes the control unit 111 and the depth estimation unit 112 to operate and outputs an estimated depth map for the space to be measured on the basis of the acoustic signal picked up by the sound pickup unit 102.

The control unit 111 and the depth estimation unit 112 constituting the estimation unit 110 will be described.

The control unit 111 controls the generation unit 101 and the sound pickup unit 102. The control unit 111 causes the generation unit 101 to operate to output the predetermined attractive sound to the space. The control unit 111 also causes the sound pickup unit 102 to operate to pick up an acoustic signal for a fixed time period starting before and ending after generation of the attractive sound. The picked-up acoustic signal is transmitted to the depth estimation unit 112 through the control unit 111 and is used as input for depth estimation.

When the acoustic signal is input, the depth estimation unit 112 subjects the acoustic signal to feature analysis and performs time-frequency feature conversion, and extracts a feature representing time-frequency information obtained through the analysis of the acoustic signal. The depth estimation unit 112 generates a depth map for the space to be measured by inputting the extracted feature representing the time-frequency information to a depth estimator of the storage unit 120 and outputs the depth map. At this time, the depth estimation unit 112 reads a parameter for the depth estimator from the storage unit 120. The depth estimation unit 112 outputs, as a depth map which is a result of depth estimation of the space to be measured, output which is obtained from the depth estimator.

The depth estimator is stored in the storage unit 120. The depth estimator is a depth estimator which is composed of one or more convolution operations, and is learned so as to output a depth map for the space to be measured when a feature representing time-frequency information is accepted as input. The parameter for the depth estimator needs to be determined through learning at least once before execution of a depth estimation process according to one example of the embodiment of the present disclosure and be recorded in the storage unit 120. The following description will be given on the premise that the depth estimator is stored in the storage unit 120 and that reading out and updating through learning processing of the depth estimator in the storage unit 120 are performed.

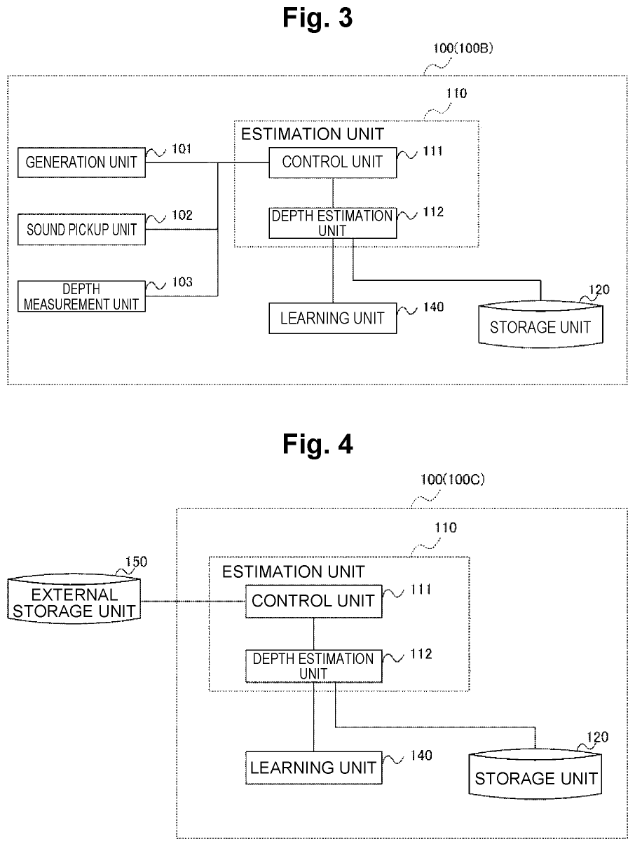

Various ones are conceivable as a configuration and a method at the time of execution of the learning processing. For example, a configuration shown in FIG. 3 can be adopted as a device configuration.

In a configuration example in FIG. 3 of the depth estimation device 100 (100B), a depth measurement unit 103 and a learning unit 140 are further provided in addition to the one device configuration example shown in FIG. 1. The units are connected to the estimation unit 110 and the storage unit 120 in a form capable of intercommunication of information.

The depth measurement unit 103 is utilized for the purpose of obtaining a depth map (hereinafter referred to as a correct depth map) which is the correct answer at the time of learning. Thus, the depth measurement unit 103 is preferably composed of a device which directly measures a depth map for the space to be measured. For example, an arbitrary publicly known one, such as a laser scanning device using LiDAR (light detection and ranging/light imaging, detection, and ranging) described earlier, a time of flight (ToF) camera using, e.g., infrared light, and a measurement device using structured illumination, can be utilized. Note that it will be appreciated that the devices are utilized only at the time of learning and need not be used at the time of actually performing depth estimation according to the present disclosure.

The depth measurement unit 103 measures a correct depth map for the space to be measured in synchronism with operation of the generation unit 101 and the sound pickup unit 102 under control of the control unit 111 and transmits the correct depth map to the depth estimation unit 112 through the control unit 111.

In the depth estimation device 100B, the depth estimation unit 112 analyzes an acoustic signal for learning which is obtained through the control unit 111 and extracts a feature representing time-frequency information. The depth estimation unit 112 then generates an estimated depth map for learning for the space to be measured which is obtained from the acoustic signal for learning by inputting the extracted feature representing the time-frequency information to the depth estimator of the storage unit 120 and outputs the estimated depth map to the learning unit 140.

The learning unit 140 updates the parameter for the depth estimator on the basis of the estimated depth map for learning and the correct depth map such that the estimated depth map for learning approaches the correct depth map and learns the parameter, and records the parameter in the storage unit 120.

Note that although FIG. 3 illustrates by example a device configuration on the premise that the depth estimation device 100B collects learning data itself, means for preparing learning data is irrelevant to the gist of the present disclosure in utilizing the present disclosure, and learning data may be prepared by arbitrary means. The configuration in FIG. 3 is thus not essential, and another configuration may be adopted. For example, a configuration as in FIG. 4 may be adopted, and learning data may be capable of being referred to from an external storage unit 150 which is outside a depth estimation device 100C through communication. In the case of the configuration, the control unit 111 appropriately reads a corresponding combination of an acoustic signal and a correct depth map from the external storage unit 150 and transmits the combination to the depth estimation unit 112 or the learning unit 140. The learning unit 140 updates a parameter for a depth estimator on the basis of learning data such that an estimated depth map to be obtained by the depth estimation unit 112 approaches the correct depth map and records the parameter in the storage unit 120.

In either one of the configuration examples, the units and the means that the depth estimation device 100 includes may be each composed of a computer, a server, or the like which includes an arithmetic processing unit, a storage device, and the like, and processing by each unit may be executed by a program. Although the program is stored in a storage device which the depth estimation device 100 includes, the program, of course, may be recorded on a recording medium, such as a magnetic disk, an optical disk, or a semiconductor memory or may be provided through a network. It will be appreciated that any other constituent element need not be implemented by a single computer or server and may be implemented by being distributed to a plurality of computers connected by a network.

[Overview of Processing]

Details of processing to be executed by the depth estimation device 100 according to the present embodiment will be described. Processing related to depth estimation according to the present embodiment is broadly divided into the two different processes: an estimation process of obtaining an estimated depth map on the basis of an input acoustic signal; and a learning process of learning the depth estimator. The following description will be given on the premise that the depth estimation device 100 (100B) performs the learning process with the configuration in FIG. 3 described above and performs the estimation process using a learned depth estimator.

When the depth estimation device 100 according to the present embodiment obtains, as input, an acoustic signal which accompanies an attractive sound output to a space to be measured and is picked up, the depth estimation device 100 estimates and outputs an estimated depth map for the space to be measured.

A depth map is a map in which a distance in a depth direction from a measurement device (the depth measurement unit 103) which is a depth at a given point in the space to be measured is stored in each pixel value of an image representing the space to be measured. An arbitrary unit can be used as a unit of distance, and meters or millimeters, for example, may be used as a unit. A correct depth map used for learning and an estimated depth map obtained through estimation are pieces of data which have the same width and height and have the same format.

[Operation of First Embodiment]

Operation of a first embodiment will be described. An acoustic signal pickup process which is preprocessing common to the learning process and the estimation process will first be described. After that, the operation of the embodiment will be described in detail for the learning process and the estimation process.

<Sound Pickup Process>

The acoustic signal pickup process will first be described. Although an arbitrary publicly known one can be utilized as an attractive sound to be utilized for sound pickup, a signal suitable for analyzing a wide range of frequency characteristics is preferably used. Specific examples include a time-stretched-pulse (TSP) signal described in Reference Literature 1.

[Reference Literature 1] N. Aoshima, “Computer-generated pulse signal applied for sound measurement,” The Journal of the Acoustical Society of America, Vol. 69, 1484, 1981

A control unit 111 outputs a TSP signal from a generation unit 101 and picks up a sound for a fixed time period starting before and ending after the outputting as an acoustic signal. The control unit 111 preferably outputs a TSP signal a plurality of times at fixed intervals and obtains an average of respective acoustic signals corresponding to the outputs. Assume that the control unit 111, for example, outputs a TSP signal four times at intervals of two seconds, a sound pickup time period is eight seconds in total, and that the control unit 111 takes an average of acoustic signals for the four times, which corresponds to an output time period of two seconds. If a sound pickup unit 102 is composed of a plurality of microphones, the control unit 111 picks up a plurality of acoustic signals.

The above is the details of the sound pickup process.

<Learning Process>

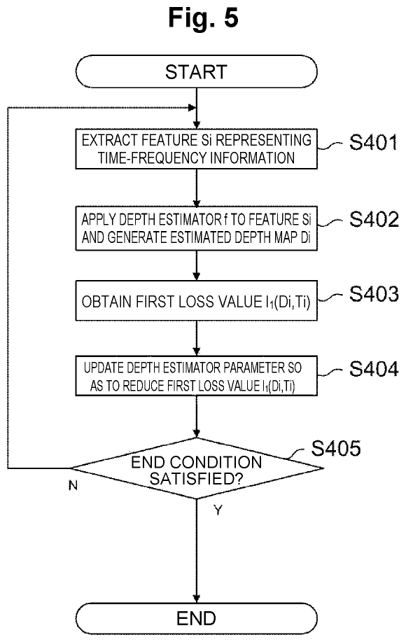

FIG. 5 is a flowchart showing the flow of the learning process by a depth estimation device 100 according to the first embodiment. A CPU 11 reads out a program from a ROM 12 or a storage 14, develops the program in a RAM 13, and executes the program, thereby performing the learning process.

Hereinafter, let Aᵢ be an acoustic signal serving as an i-th input; Tᵢ, a corresponding correct depth map; and Dᵢ, an estimated depth map estimated by the depth estimation unit 112. Also, let Tᵢ(x,y) and Dᵢ(x,y) be pixel values, respectively, at coordinates (x,y) of the correct depth map Tᵢ and the estimated depth map Dᵢ.

The learning process according to the embodiment of the present disclosure is executed by the following steps. Note that i is initialized as i=1.

First, in step S401, the CPU 11 as a depth estimation unit 112 subjects the acoustic signal Aᵢ to feature extraction processing and extracts a feature Sᵢ which represents time-frequency information.

In succeeding step S402, the CPU 11 as the depth estimation unit 112 applies a depth estimator f to the feature Sᵢ and generates the estimated depth map Dᵢ=f(Sᵢ).

In succeeding step S403, the CPU 11 as a learning unit 140 obtains a first loss value l₁(Dᵢ,Tᵢ) on the basis of the estimated depth map Dᵢ and the correct depth map Tᵢ.

In succeeding step S404, the CPU 11 as the learning unit 140 updates a depth estimator parameter so as to reduce the first loss value l₁(Dᵢ,Tᵢ) and records the parameter in a storage unit 120.

In succeeding step S405, the CPU 11 determines whether a predetermined end condition is satisfied. If the predetermined end condition is satisfied, the CPU 11 ends the process. Otherwise, the CPU 11 increments i (i←i+1) and returns to S401. An arbitrary one may be defined as the end condition. For example, “the end condition that the process ends if a predetermined number of repetitions (e.g., 100 repetitions) are performed” or “the end condition that the process ends if a reduction in the first loss value remains within a fixed range during a fixed number of repetitions” may be defined.

As described above, the learning unit 140 updates the parameter on the basis of the first loss value l₁(Dᵢ,Tᵢ) that is obtained from an error between the generated estimated depth map Dᵢ for learning and the correct depth map Tᵢ.

Examples according to the present embodiment of respective detailed processes of the processes in steps S401, S402, S403, and S404 described above will be described hereinafter.

[Step S401: Feature Extraction Process]

An example of a feature extraction process to be executed by the depth estimation unit 112 will be described. The feature extraction process extracts, from the acoustic signal Aᵢ as input, the feature Sᵢ representing time-frequency information of the acoustic signal. For the process, a publicly known spectral analysis method can be used. Although any spectral analysis method may be used in utilizing the present disclosure, for example, a short-time Fourier transform may be applied, and a time-frequency spectrum may be obtained. Alternatively, a mel-cepstrum, a mel-frequency cepstrum coefficient (MFCC), or the like may be used.

The feature Sᵢ that is obtained by the above-described feature extraction process is a two-dimensional or three-dimensional array. The size of an array is generally t×b, which is a size depending on the number t of time windows and the number b of frequency bins. In a three-dimensional case, values for two channels, a real component and a complex component, are further stored in an array, and the size of the array is t×b×2.

If there are a plurality of acoustic signals (e.g., if the sound pickup unit 102 is composed of a plurality of microphones), the depth estimation unit 112 may apply the above-described process to each acoustic signal and unite results into one array. For example, if the sound pickup unit 102 is composed of four microphones, and four acoustic signals are obtained, the depth estimation unit 112 combines four arrays in the third dimension to form an array of a size of t×b×8 and regards the array as the feature Sᵢ.

Additionally, an arbitrary feature other than the above-described ones can be utilized as long as the feature can be expressed as an array. For example, an angle spectrum described in Reference Literature 2, or the like is an example. Alternatively, a plurality of features may be combined and utilized.

[Reference Literature 2] C. Knapp and G. Carter, “The generalized cross-correlation method for estimation of time delay,” IEEE Trans. Acoustics, Speech, and Signal Processing, vol. 24, pp. 320-327, 1976.

The above is an example of the feature extraction process.

[Step S402: Depth Estimation Process]

The depth estimation unit 112 applies the depth estimator f to the feature Sᵢ and obtains the estimated depth map Dᵢ=f(Sᵢ).

Although the depth estimation unit 112 can use, as the depth estimator f, an arbitrary function which can accept as input the feature Sᵢ and output the estimated depth map Dᵢ, a convolutional neural network which is composed of one or more convolution operations is used in the present embodiment. An arbitrary configuration can be adopted as a configuration of the neural network as long as the configuration can implement the above-described input-output relation. For example, the one described in Non-Patent Literature 1 or 2, one based on a DenseNet described in Reference Literature 3, or the like may be used.

[Reference Literature 3] Gao Huang, Zhuang Liu, Laurens van der Maaten, and Kilian Q. Weinberger, “Densely Connected Convolutional Network,” In Proc. Conference on Computer Vision and Pattern Recognition (CVPR), 2017.

A configuration of a neural network according to the present disclosure is not limited to the above-described ones, and any configuration may be adopted as long as the configuration satisfies the input-output requirement described earlier. Preferably, a neural network is configured using a deconvolution layer/upconvolution layer and an upsampling layer so as to be capable of outputting a high-resolution estimated depth map.

If a plurality of features are utilized, for example, the following configuration can be used. One or more convolution layers which individually process various types of features and an activation function (ReLU) are provided, a fully connected layer is then provided to unite the features into one, and a deconvolution layer is finally used to output a single estimated depth map.

The above is an example of the depth estimation process.

[Step S403: First Loss Function Calculation Process]

The learning unit 140 obtains a first loss value on the basis of the correct depth map Tᵢ corresponding to the acoustic signal Aᵢ and the estimated depth map Dᵢ estimated by the depth estimator f.

Through the processes to step S403, the estimated depth map Dᵢ estimated by the depth estimator f is obtained for the acoustic signal Aᵢ that is learning data. The estimated depth map Dᵢ should be a result of estimating the correct depth map Tᵢ. For this reason, it is preferably a basic policy to design a first loss function such that the first loss function yields a smaller loss value if the estimated depth map Dᵢ is closer to the correct depth map Tᵢ and yields a larger loss value if the estimated depth map Dᵢ is more distant.

In the simplest case, a sum total of distances between pixel values of the estimated depth map Dᵢ and the correct depth map Tᵢ may be used as a loss function, as disclosed in Non-Patent Literature 3. For example, if an L1 distance is used as a pixel value distance, the first loss function can be defined as in Expression (1) below.

$$\begin{matrix}[ Math . 1 ] & \\ {l}_{L 1} ( {T}_{i} , {D}_{i} ) = \frac{1}{N} {\sum }_{i = 1}^{N} {\sum }_{y ∈ {Y}_{i}} {\sum }_{x ∈ {X}_{i}} \vert {e}_{i} ( x , y ) \vert & ( 1 )\end{matrix}$$

The symbol Xi in Expression (1) above represents a domain for x, and the symbol Yi represents a domain for y. The symbols x and y represent positions of a pixel on each depth map. The symbol N is the number of sets, each having a depth map as learning data and a correct depth map, or a constant not more than the number of sets. As for eᵢ(x,y), eᵢ(x,y)=Tᵢ(x,y)−Dᵢ(x,y) holds, and eᵢ(x,y) is an error between respective pixels of the estimated depth map Dᵢ for learning and the correct depth map Tᵢ.

The first loss function takes a smaller value with approach to a situation where pixels of the correct depth map Tᵢ and pixels of the estimated depth map Dᵢ are all equal and is 0 if Tᵢ=Dᵢ. That is, a depth estimator capable of outputting a correct estimated depth map can be achieved by updating a depth estimator parameter so as to reduce the value for various Tᵢ and Dᵢ.

Alternatively, like the method disclosed in Non-Patent Literature 1, the loss function in Expression (2) below may be used as the first loss function.

$$\begin{matrix}[ Math . 2 ] & \\ {l}_{BerHu} ( {T}_{i} , {D}_{i} ) = \frac{1}{N} {\sum }_{i = 1}^{N} {\sum }_{y ∈ {Y}_{i}} {\sum }_{x ∈ {X}_{i}} {d}_{i} ( x , y ) \\ {d}_{i} ( x , y ) = \{ \begin{matrix}\vert {e}_{i} ( x , y ) \vert & if \vert {e}_{i} ( x , y ) \vert \leq c \\ \frac{{( {e}_{i} ( x , y ) )}^{2} + {c}^{2}}{2 c} & ohterwise\end{matrix} & ( 2 )\end{matrix}$$

The loss function in Expression (2) is a function which is linear within a range with a small depth estimation error and is a quadratic function within a range with a large depth estimation error.

The existing loss function as indicated by Expression (1) above or Expression (2) above suffers from a problem. A region corresponding to pixels, the error |eᵢ(x,y)| for which is large, of the depth maps may be physically at a great distance. Alternatively, the region corresponding to the pixels, the error |eᵢ(x,y)| for which is large, of the depth maps may be a portion having a very complicated depth structure.

Such spots of each depth map are often regions with uncertainty. For this reason, the spots of the depth map are often not regions, depths of which can be estimated with high accuracy by the depth estimator f. Thus, learning with an emphasis on a region including a pixel, the error |eᵢ(x,y)| for which is large, of each depth map does not always improve the accuracy of the depth estimator f.

The loss function in Expression (1) above always has the same first loss value regardless of the magnitude of the error |eᵢ(x,y)|. In contrast, the loss function in Expression (2) above is designed to have a larger first loss value if the error |eᵢ(x,y)| is larger. For this reason, even if the depth estimator f is caused to be learned using the loss function as indicated by Expression (1) above or Expression (2) above, there is a limit to improving the accuracy of estimation by the depth estimator f.

Under the circumstances, in the present embodiment, a first loss function which is a loss function as indicated by Expression (3) below is used.

$$\begin{matrix}[ Math . 3 ] & \\ {l}_{1} ( {T}_{i} , {D}_{i} ) = \frac{1}{N} {\sum }_{i = 1}^{N} {\sum }_{y ∈ {Y}_{i}} {\sum }_{x ∈ {X}_{i}} {d}_{i} ( x , y ) \\ {d}_{i} ( x , y ) = \{ \begin{matrix}\vert {e}_{i} ( x , y ) \vert & if \vert {e}_{i} ( x , y ) \vert \leq c \\ \sqrt{2 c \vert {e}_{i} ( x , y ) \vert - {c}^{2}} & ohterwise\end{matrix} & ( 3 )\end{matrix}$$

A first loss value of the first loss function is a first loss value which increases linearly with increase in an absolute value |eᵢ(x,y)| of the error if the error |eᵢ(x,y)| is not more than a threshold c. The first loss value of the first loss function is a first loss value which changes with a root of the error |eᵢ(x,y)| if the error |eᵢ(x,y)| is more than the threshold c.

The first loss function in Expression (3) above is the same as another loss function (e.g., the loss function in Expression (1) above or Expression (2) above) in that the first loss function increases linearly with increase in |eᵢ(x,y)| for a pixel, the error |eᵢ(x,y)| for which is not more than the threshold c.

The first loss function in Expression (3) above, however, is a function which serves as a square function with increase in |eᵢ(x,y)| for a pixel, the error |eᵢ(x,y)| for which is more than the threshold c. For this reason, in the present embodiment, a loss value is underestimated for a pixel with uncertainty, and the pixel is disregarded, as described above. This allows enhancement of robustness of estimation by the depth estimator f and improvement of accuracy.

For the above-described reason, the learning unit 140 obtains, by Expression (3) above, the first loss value l₁ from an error between the estimated depth map for learning and the correct depth map for the estimated depth map for learning and causes the depth estimator f to be learned so as to reduce a value of the first loss value l₁.

Note that the first loss function in Expression (3) above can be differentiated piecewise with respect to a parameter w for the depth estimator f. For this reason, the parameter w for the depth estimator f can be updated by a gradient method. For example, if the parameter w for the depth estimator f is caused to be learned on the basis of stochastic gradient descent, the learning unit 140 updates the parameter w on the basis of Expression (4) below per step. Note that a is a coefficient set in advance.

$$\begin{matrix}[ Math . 4 ] & \\ w ← w - α \frac{\partial }{\partial w} {l}_{1} & ( 4 )\end{matrix}$$

A derivative value of a loss function for the arbitrary parameter w for the depth estimator f can be calculated by an error back propagation method. Note that the learning unit 140 may introduce a general improved version of stochastic gradient descent, such as utilization of a momentum term or utilization of weight decay, at the time of causing the parameter w for the depth estimator f to be learned. Alternatively, the learning unit 140 may use another gradient descent method to cause the parameter w for the depth estimator f to be learned.

The learning unit 140 stores, in the depth estimator, the learned parameter w for the depth estimator f. With this storage, the depth estimator f for estimating a depth map with high accuracy is obtained.

The above is a process to be performed in step S404.

<Estimation Process>

An estimation process of a depth estimation method according to one example of the present embodiment will be described.

The estimation process is very simple with use of a depth estimator having undergone the learning process. Specifically, the depth estimation unit 112 executes the feature extraction process performed in step S401 above after acquiring an acoustic signal through the above-described sound pickup process. The depth estimation unit 112 may obtain an estimated depth map as output by executing the depth estimation process described with reference to step S402 above.

The above is the estimation process of the depth estimation method according to the one example of the present embodiment.

As it has been described above, a depth estimation device according to the first embodiment can learn a depth estimator for estimating a depth of a space with high accuracy using an acoustic signal. It is also possible to estimate a depth of a space with high accuracy using an acoustic signal.

[Operation of Second Embodiment]

Operation of a second embodiment will be described. The second embodiment is different from the first embodiment in that a depth estimator f is caused to be learned so as to reduce an error between an edge representing the degree of change in depth of an estimated depth map for learning and an edge representing the degree of change in depth of a correct depth map.

In the second embodiment, a sound pickup process is performed in the same manner as in the first embodiment.

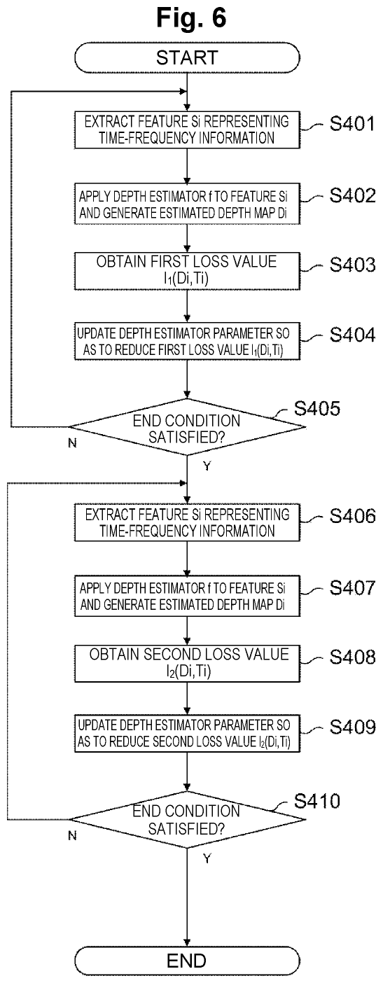

FIG. 6 is a flowchart showing the flow of a learning process by a depth estimation device 100 according to the second embodiment. A CPU 11 reads out a program from a ROM 12 or a storage 14, develops the program in a RAM 13, and executes the program, thereby performing the learning process.

Steps S401 to S405 are the same as those in the first embodiment.

In step S406, the CPU 11 as a depth estimation unit 112 subjects an acoustic signal Aᵢ to feature extraction processing and extracts a feature Sᵢ. Note that the processing is totally the same as in step S401 and that, if a configuration in which a feature Sᵢ obtained earlier in step S401 is already stored is adopted, the process in step S406 is unnecessary.

In succeeding step S407, the CPU 11 as the depth estimation unit 112 applies the depth estimator f to the feature Sᵢ and generates an estimated depth map Dᵢ=f(Sᵢ).

In succeeding step S408, the CPU 11 as a learning unit 140 obtains a second loss value l₂(Dᵢ,Tᵢ) on the basis of the estimated depth map Dᵢ, a correct depth map Tᵢ, and an edge detector.

In succeeding step S409, the CPU 11 as the learning unit 140 updates a depth estimator parameter so as to reduce the second loss value l₂(Dᵢ,Tᵢ) and records the parameter.

Finally, in step S410, the CPU 11 as the learning unit 140 determines whether a predetermined end condition is satisfied and, if the condition is satisfied, ends the process. If the condition is not satisfied, the CPU 11 increments i (i←i+1) and returns to S406. An arbitrary one may be defined as the end condition. For example, “the end condition that the process ends if a predetermined number of repetitions (e.g., 100 repetitions) are performed” or “the end condition that the process ends if a reduction in a second loss value remains within a fixed range during a fixed number of repetitions” may be defined.

As described above, the learning unit 140 updates the parameter for the updated depth estimator on the basis of the second loss value l₂(Dᵢ,Tᵢ) obtained through reflection of edges detected for a space to be measured in an error, thereby learning the depth estimator.

One example according to the present embodiment of a detailed process of the process in step S408 above will be described hereinafter.

[Step S408: Second Loss Calculation Process]

An estimated depth map which is output by the depth estimator obtained by the processes in steps S401 to S405 may be excessively smooth and be blurred overall especially if a convolutional neural network is used as the depth estimator. Such a blurred estimated depth map has the disadvantage that the estimated depth map does not correctly reflect a depth of an edge portion where a depth changes sharply, such as a boundary between walls or a verge of an object. Under the circumstances, in the second embodiment, the second loss value l₂ is introduced in order to improve a depth, and the depth estimator parameter is further updated so as to minimize the second loss value l₂.

A desirable design is such that an edge in a correct depth map and an edge in an estimated depth map are close. For this reason, in the second embodiment, a second loss function indicated by Expression (5) below is introduced. The depth estimation device 100 according to the second embodiment further updates a parameter w for the depth estimator f so as to minimize a second loss value of the second loss function in Expression (5) below.

$$\begin{matrix}[ Math . 5 ] & \\ {l}_{2} ( {T}_{i} , {D}_{i} ) = \frac{1}{N} {\sum }_{i = 1}^{N} {\sum }_{y ∈ {Y}_{i}} {\sum }_{x ∈ {X}_{i}} \vert E ( {T}_{i} ( x , y ) ) - E ( {D}_{i} ( x , y ) ) \vert & ( 5 )\end{matrix}$$

Here, the symbol E in Expression (5) above is an edge detector, and the portion E(Dᵢ(x,y)) represents a value at coordinates (x,y) after application of the edge detector E to the correct depth map Tᵢ. Also, the portion E(Dᵢ(x,y)) represents a value at coordinates (x,y) after application of the edge detector E to the estimated depth map Dᵢ for learning.

Any edge detector may be used as the edge detector as long as the edge detector is a detector which is capable of differentiation. For example, the Sobel filter can be used as the edge detector. The Sobel filter has the advantage that since the Sobel filter can be described as a convolution operation, the Sobel filter can be simply implemented as a convolution layer of a convolutional neural network.

The above is the process to be performed in step S408.

[Step S409: Parameter Updating]

The learning unit 140 updates the depth estimator parameter so as to reduce the second loss value obtained in step S408.

The second loss function defined in Expression (5) above can also be differentiated piecewise with respect to the parameter w for the depth estimator f as long as the edge detector E is capable of differentiation. For this reason, the parameter w for the depth estimator f can be updated by a gradient method. For example, if the parameter w for the depth estimator f is caused to be learned on the basis of stochastic gradient descent, the learning unit 140 according to the second embodiment updates the parameter w on the basis of Expression (6) below per step. Note that α is a coefficient set in advance.

$$\begin{matrix}[ Math . 6 ] & \\ w ← w - α \frac{\partial }{\partial w} {l}_{2} & ( 6 )\end{matrix}$$

As described above, the learning unit 140 according to the second embodiment updates the parameter on the basis of the second loss value obtained through reflection of the edges that are the degrees of change in depth in the error, thereby learning the depth estimator. The learning unit 140 causes the depth estimator f to be further learned so as to reduce an error between the edge E(Dᵢ(x,y)) represented by the correct depth map Tᵢ and the edge E(Dᵢ(x,y)) representing the degree of change in depth of the estimated depth map Dᵢ for learning. Specifically, the learning unit 140 according to the second embodiment causes the depth estimator f to be further learned so as to reduce the second loss value of the second loss function indicated by Expression (5) above.

Note that the depth estimation device 10 according to the second embodiment causes the parameter w for the depth estimator f, learned once by the first loss function in Expression (3) above, to be updated again by the second loss function in Expression (5) above. This does not result in reduction in the accuracy of estimation by the depth estimator f.

In a general case where the parameter w for the depth estimator f is caused to be learned so as to minimize both the loss functions, the first loss function in Expression (3) above and the second loss function in Expression (5) above, a linear combination of the first loss function in Expression (3) above and the second loss function in Expression (5) above is defined as a new loss function. The parameter w for the depth estimator f is updated so as to minimize the new loss function.

In contrast, one feature of the second embodiment is that the first loss function in Expression (3) above and the second loss function in Expression (5) above are individually minimized. A learning method of the depth estimation device 10 according to the second embodiment has the advantage that the parameter w for the depth estimator f can be caused to be learned even without manual adjustment of a weight for linear combination, as compared to a case where a new loss function obtained through linear combination of the first loss function in Expression (3) above and the second loss function in Expression (5) above is minimized. Individual updating is possible because the degree of mutual interference between a parameter to be updated by the first loss function and a parameter to be updated by the second loss function is considered as low.

Weight adjustment in a case where the first loss function in Expression (3) above and the second loss function in Expression (5) above are linearly combined is generally very difficult. The weight adjustment needs the costly work of repeating learning again and again while varying a weight for linear combination and identifying the best weight. In contrast, the learning method of the depth estimation device 10 according to the second embodiment can avoid such work.

Note that an estimation process is the same as that in the first embodiment and that a description thereof will be omitted.

As it has been described above, a depth estimation device according to the second embodiment can learn a depth estimator for estimating a depth of a space with high accuracy in view of the degree of change in space, using an acoustic signal. It is also possible to estimate a depth of a space with high accuracy, using an acoustic signal.

The above-described embodiments allow estimation of an estimated depth map by not using a camera and a special device for depth measurement and using only a speaker as a generation device and a microphone as a sound pickup device.

An attractive sound generated by a speaker hits a wall or an object in a space. As a result, the attractive sound is picked up with echo and reverberation by a microphone. That is, since an attractive sound picked up by a microphone has information as to where and how the attractive sound is reflected, information including a depth of a space can be estimated by analyzing the sound.

Attempts have been made before to estimate a depth of a space by utilizing acoustic information including such reverberation and echo. For example, in Non-Patent Literature 4, a relation between a time of arrival of an acoustic signal and a shape of a room is modelized through acoustic signal processing. There is also known a method for measuring a distance from a subject on the basis of a difference in time of arrival and power of a reflected wave, as typified by SONAR (Sound Navigation and Ranging). This analytic method, however, has a limitation in applicable space. For example, in Non-Patent Literature 4, the method cannot be applied unless a room is a space having a relatively simple shape, such as a convex polyhedral shape. Under the current circumstances, utilization of SONAR for depth measurement is confined chiefly to under water.

In contrast, in the above-described embodiments, an estimated depth map is predicted not by an analytic method but through prediction using a convolutional neural network. Thus, an estimated depth map for a space can be estimated through statistical inference even if the space is a space in which a solution cannot be analytically found.

Note that since an acoustic signal propagates regardless of brightness of a room, an acoustic signal is available for a dark room interior which is invisible to a camera or a space which is not desired to be shot with a camera, unlike a conventional depth estimation technique using a camera.

Note that multitask learning, which is executed in each of the above-described embodiments by a CPU reading software (a program), may be executed by various types of processors other than a CPU. A processor in this case is exemplified by, e.g., a PLD (Programmable Logic Device) whose circuit configuration can be changed after manufacture, such as an FPGA (Field-Programmable Gate Array), and a dedicated electric circuit which is a processor having a circuit configuration designed specifically for execution of a particular process, such as an ASIC (Application Specific Integrated Circuit). Multitask learning may be executed by one of these various types of processors or may be executed by a combination of two or more processors of the same type or different types (e.g., a combination of a plurality of FPGAs or a combination of a CPU and an FPGA). More specifically, a hardware structure of each of these various types of processors is an electric circuit which is a combination of circuit elements, such as a semiconductor element.

Although each of the embodiments has described an aspect where a multitask learning program is stored in advance (installed) in the storage 14, the present disclosure is not limited to these. A program may be provided in a form stored in a non-transitory storage medium, such as a CD-ROM (Compact Disk Read Only Memory), a DVD-ROM (Digital Versatile Disk Read Only Memory), and a USB (Universal Serial Bus) memory. The program may be downloaded from an external device via a network.

As for the above-described embodiments, the following additions are further disclosed.

(Additional Item 1)

A depth estimation device including

a memory, and

at least one processor connected to the memory,

wherein the processor is configured to

generate a predetermined attractive sound in a space to be measured,

pick up an acoustic signal for a predetermined time period corresponding to a time period before and after a time of generation of the attractive sound by a generation unit,

extract a feature representing time-frequency information obtained through analysis of the acoustic signal, on the basis of the acoustic signal, and

input the extracted feature representing the time-frequency information to a depth estimator and generate an estimated depth map for the space to be measured, the depth estimator being composed of one or more convolution operations and being learned so as to output an estimated depth map, in which a depth is assigned to each of pixels of an image representing the space to be measured, when a feature representing the time-frequency information is input.

(Additional Item 2)

A non-transitory storage medium storing a depth estimation program, the program causing a computer to execute

generating a predetermined attractive sound in a space to be measured,

picking up an acoustic signal for a predetermined time period corresponding to a time period before and after a time of generation of the attractive sound by a generation unit,

extracting a feature representing time-frequency information obtained through analysis of the acoustic signal, on the basis of the acoustic signal, and

inputting the extracted feature representing the time-frequency information to a depth estimator and generating an estimated depth map for the space to be measured, the depth estimator being composed of one or more convolution operations and being learned so as to output an estimated depth map, in which a depth is assigned to each of pixels of an image representing the space to be measured, when a feature representing the time-frequency information is input.

### REFERENCE SIGNS LIST

100 (100A, 100B, 100C) Depth estimation device
101 Generation unit
102 Sound pickup unit
103 Depth measurement unit
110 Estimation unit
111 Control unit
112 Depth estimation unit
120 Storage unit
140 Learning unit
150 External storage unit

1. A depth estimation device comprising:
a generator that generates a predetermined attractive sound in a space to be measured;
a sound pickup unit that picks up an acoustic signal for a predetermined time period corresponding to a time period before and after a time of generation of the attractive sound by the generation unit; and
an estimation unit that extracts a feature representing time-frequency information obtained through analysis of the acoustic signal, on the basis of the acoustic signal, and inputs the extracted feature representing the time-frequency information to a depth estimator and generates an estimated depth map for the space to be measured, the depth estimator being composed of one or more convolution operations and being learned so as to output an estimated depth map, in which a depth is assigned to each of pixels of an image representing the space to be measured, when a feature representing the time-frequency information is input.

2. The depth estimation device according to claim 1, further comprising
a learning unit,
wherein the depth estimator is learned by
extracting, by the estimation unit, a feature representing time-frequency information through frequency analysis of a picked-up acoustic signal for learning and applying the depth estimator to the time-frequency information to generate an estimated depth map for learning, and
updating, by the learning unit, a parameter for the depth estimator on the basis of a first loss value that is obtained from an error between the generated estimated depth map for learning and a correct depth map for the estimated depth map for learning.

3. The depth estimation device according to claim 2, wherein
the depth estimator is learned by
updating, by the learning unit, the parameter for the depth estimator on the basis of a second loss value obtained through reflection of edges detected for the space to be measured in the error, for the depth estimator updated on the basis of the first loss value.

4. A depth estimation method comprising:
generating a predetermined attractive sound in a space to be measured;
picking up an acoustic signal for a predetermined time period corresponding to a time period before and after a time of generation of the attractive sound by a generation unit;
extracting a feature representing time-frequency information obtained through analysis of the acoustic signal, on the basis of the acoustic signal; and
inputting the extracted feature representing the time-frequency information to a depth estimator and generating an estimated depth map for the space to be measured, the depth estimator being composed of one or more convolution operations and being learned so as to output an estimated depth map, in which a depth is assigned to each of pixels of an image representing the space to be measured, when a feature representing the time-frequency information is input.

5. The depth estimation method according to claim 4, wherein
the depth estimator is learned by
extracting a feature representing time-frequency information through frequency analysis of a picked-up acoustic signal for learning and applying the depth estimator to the time-frequency information to generate an estimated depth map for learning, and
updating a parameter for the depth estimator on the basis of a first loss value that is obtained from an error between the generated estimated depth map for learning and a correct depth map for the estimated depth map for learning.

6. The depth estimation method according to claim 5, wherein
the depth estimator is learned by updating the parameter for the depth estimator on the basis of a second loss value obtained through reflection of edges detected for the space to be measured in the error, for the depth estimator updated on the basis of the first loss value.

7. A computer-readable medium having a depth estimation program embodied thereon for causing a computer to execute the following steps:
generating a predetermined attractive sound in a space to be measured;
picking up an acoustic signal for a predetermined time period corresponding to a time period before and after a time of generation of the attractive sound by a generation unit;
extracting a feature representing time-frequency information obtained through analysis of the acoustic signal, on the basis of the acoustic signal; and
inputting the extracted feature representing the time-frequency information to a depth estimator and generating an estimated depth map for the space to be measured, the depth estimator being composed of one or more convolution operations and being learned so as to output an estimated depth map, in which a depth is assigned to each of pixels of an image representing the space to be measured, when a feature representing the time-frequency information is input.
